(19) United States
(12) Patent Application Publication
(10) Pub. No.: US 2023/0253673 A1
(43) Pub. Date: Aug. 10, 2023

(54) A SHIELDING ARTICLE

(71) Applicant: NEOGRAF SOLUTIONS, LLC, Lakewood, OH (US)

(72) Inventors: Jonathan TAYLOR, Mayfield, OH (US); Greg KRAMER, Twinsburg, OH (US); David STUART, Columbia Station, OH (US); Bret TRIMMER, Middlefield, OH (US); Chad FINKBEINER, Highland Heights, OH (US)

(21) Appl. No.: 18/002,953

(22) PCT Filed: Jun. 22, 2021
(86) PCT No.: PCT/US2021/038352

§ 371 Date: Dec. 22, 2022

Related U.S. Application Data
(60) Provisional application No. 63/043,468, filed on Jun. 24, 2020.
(60) Provisional application No. 63/068,452, filed on Aug. 21, 2020.

(51) Int. Cl. H01M 50/383; B32B 9/04; B32B 9/00; B32B 5/18; B32B 5/02; B32B 27/28; H01M 50/293; H01M 10/653

(52) U.S. Cl. CPC H01M 50/383; B32B 9/046; B32B 9/007; B32B 9/041; B32B 5/18; B32B 9/04; B32B 5/024; B32B 9/047; B32B 27/283; B32B 9/045; H01M 50/293; H01M 10/653; B32B 2307/7376; B32B 2307/302; B32B 2262/101; B32B 2262/106; B32B 2262/108; B32B 2307/304; B32B 2439/40

(57) ABSTRACT

Shielding articles are disclosed. One shielding article includes a fire retardancy element/fire propagation reduction element, which includes a pair of flexible graphite outer layers and a core, where the flexible graphite outer layers are on opposing sides of the core. The core may include one or more fire retardant elements or insulation materials. Also disclosed are battery packs that include the shielding articles. The shielding articles can be applied in any system that reduced fire propagation would be desirable.

### CROSS-REFERENCE TO RELATED APPLICATIONS

This application claims priority to and the benefit of U.S. Provisional Patent Application No. 63/043,468, filed on Jun. 24, 2020, and U.S. Provisional Patent Application No. 63/068,452, filed on Aug. 21, 2020, the entire contents of which are incorporated herein by reference.

### BACKGROUND

As lithium ion batteries become more prevalent in society, the risks associated with using them have also become more well known. One example of such risks is that the electrolyte for such batteries is known to be flammable. While such batteries are known to exhibit the advantageous property of generating large amounts of energy, they are also known to be a fire and/or explosion risk, e.g., Tesla electric vehicles as well as consumer devises such as hoverboards, vaping devices or cell phones.

### SUMMARY

An embodiment disclosed herein is a battery pack having improved fire retardancy/reduced propagation. Such battery packs include a battery housing (AKA casing or enclosure). The housing may include a floor, one or more vertical walls and a lid. Included in the battery housing is a plurality of battery cells. The battery cells are disposed above the floor and below the lid and are further enclosed by the one or more vertical walls.

The system may further include a fire retardancy element/fire propagation reduction element. One example of such an element may include a pair of flexible graphite outer layers and a foam core. The flexible graphite outer layers are on opposing sides of the core. Preferably the flexible graphite layers are substantially not in physical contact. Further preferably the flexible graphite layers are separated by the foam core. The foam core may include one or more fire retardant elements. One such fire retardant element may include an intumescent element such as expandable graphite.

The fire retardancy element/fire propagation reduction element applications are not limited to use in a battery pack. The element has application in any system that reduced fire propagation would be desirable.

The subject matter will be further disclosed in the detailed description.

### BRIEF DESCRIPTION OF THE DRAWINGS

FIG. 1 is an exemplary article in accordance with the present disclosure comprising two flexible graphite sheets attached to a core.

FIG. 2 is an exemplary article in accordance with the present disclosure comprising one flexible graphite sheet attached to an insulation layer.

FIG. 3 is an exemplary article in accordance with the present disclosure comprising one graphite doped silicon layer attached to an insulation layer.

FIG. 4 is an exemplary article in accordance with the present disclosure comprising two insulation layers (of the same or different material) attached to one flexible graphite sheet.

FIG. 5 is an exemplary article in accordance with the present disclosure comprising an article in accordance with FIG. 1, but also with at least one metallic backing layer.

FIG. 6 is an exemplary article in accordance with the present disclosure comprising an article in accordance with FIG. 1, but also with at least one electrically isolating layer.

FIGS. 7(A) and 7(B) are exemplary battery packs in accordance with the present disclosure comprising battery cells and articles in accordance with FIG. 1 inside the battery housing. In FIG. 7(A), each of the articles in accordance with FIG. 1 is in contact with at least one surface of the battery housing. In FIG. 7(B), each of the articles is in contact with more than one surface of the battery housing.

FIGS. 8(A) and 8(B) are an exemplary battery packs in accordance with the present disclosure comprising battery cells and articles in accordance with FIG. 1 inside the battery housing. In FIG. 8(A), each of the articles in accordance with FIG. 1 are in contact with at least one surface of the battery housing or between adjacent battery cells. In FIG. 8(B), each of the articles is in contact with more than one surface of the battery housing or between adjacent battery cells.

FIG. 9 is an exemplary battery pack in accordance with the present disclosure comprising battery cells and articles in accordance with FIG. 1 in contact with more than one surface outside the battery housing, and between adjacent battery cells.

FIG. 10 is an exemplary battery pack in accordance with the present disclosure comprising battery cells and articles in accordance with FIG. 1 in contact with more than one surface outside the battery housing, and inside the battery housing in contact with the vertical surfaces of the battery housing.

FIG. 11 is an exemplary battery pack in accordance with the present disclosure comprising battery cells and articles in accordance with FIG. 1 in contact with all surfaces inside the battery housing, and between all sides of the adjacent battery cells.

FIG. 12(A) is a side view at the completion of testing for Sample A of the Example.

FIG. 12(B) is a side view at the completion of testing for Sample B of the Example.

FIG. 12(C) is a side view at the completion of testing for Sample C of the Example.

FIG. 12(D) is a side view at the completion of testing for Sample D of the Example.

FIG. 12(E) is a side view at the completion of testing for Sample E of the Example.

FIG. 13(A) is a chart of the temperature profile for Sample A of the Example.

FIG. 13(B) is a chart of the temperature profile for Sample B of the Example.

FIG. 13(C) is a chart of the temperature profile for Sample C of the Example.

FIG. 13(D) is a chart of the temperature profile for Sample D of the Example.

FIG. 13(E) is a chart of the temperature profile for Sample E of the Example.

FIG. 14 is a chart of the temperature profile for the control of the Example.

### DETAILED DESCRIPTION

The graphite article (RFPE) disclosed herein will be disclosed in terms of use in a battery pack. However the graphite article disclosed herein has application in any environment that reduced fire propagation is desirable, such as the fire wall of a vehicle, insulation for or casing of a battery operated device, energy storage system, rapid release of energy shield or an insulation element of a heated device.

The battery packs disclosed here in is not limited to any particular type of battery. Examples of suitable battery cells which may be used to practice the disclosure include cylindrical batteries, pouch cell batteries, prismatic batteries or any combination thereof.

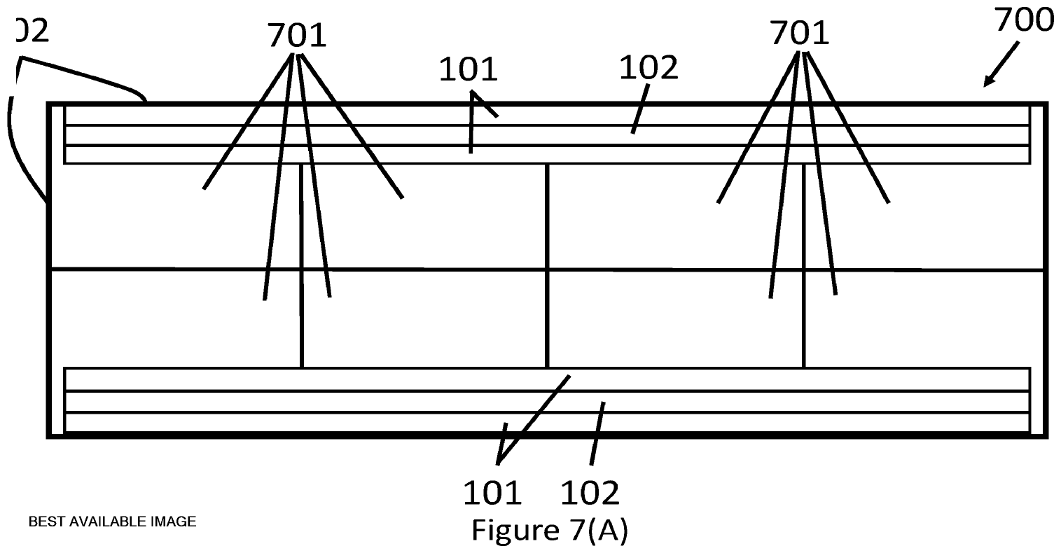

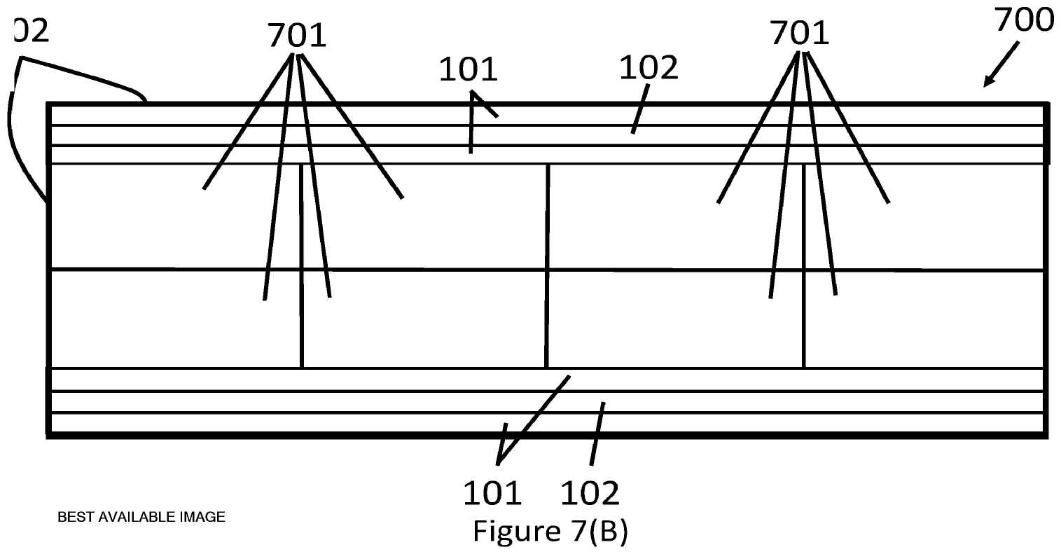

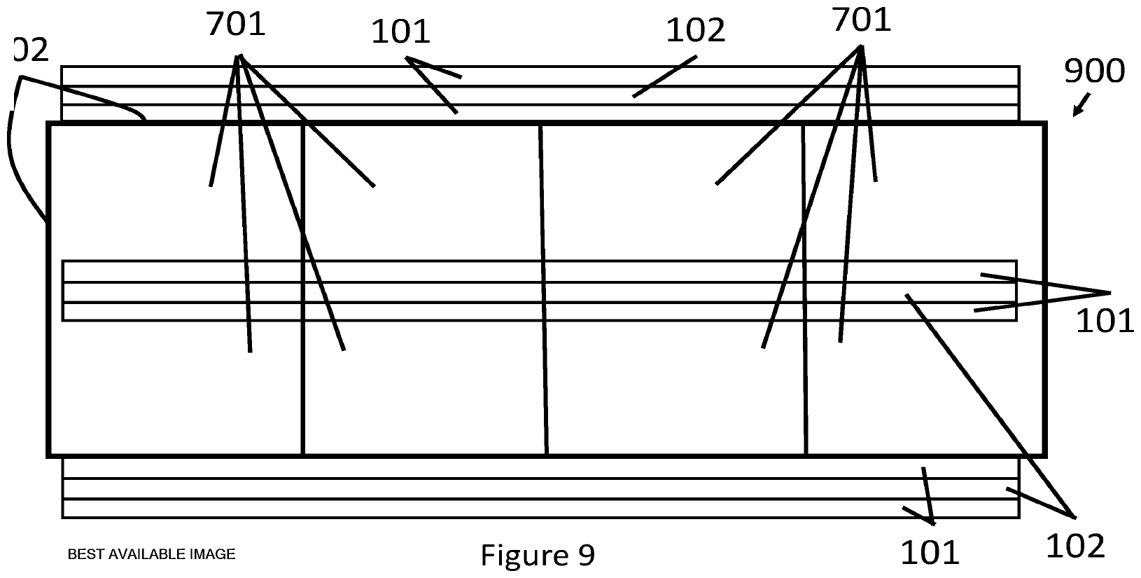

In general terms the power system for a battery operated device includes a battery pack 700, 800, 900, 1000, 1100, as shown in FIGS. 7-11, which is the overall power element for the device. The pack includes a battery housing 702 which consists of a plurality of surfaces, e.g., a floor, a lid and one or more vertical surfaces. The surfaces of the housing is aligned to enclose (encase) the plurality of cells 701. The battery pack may include other elements as desired. Examples of such elements may include a heat sink or cold plate.

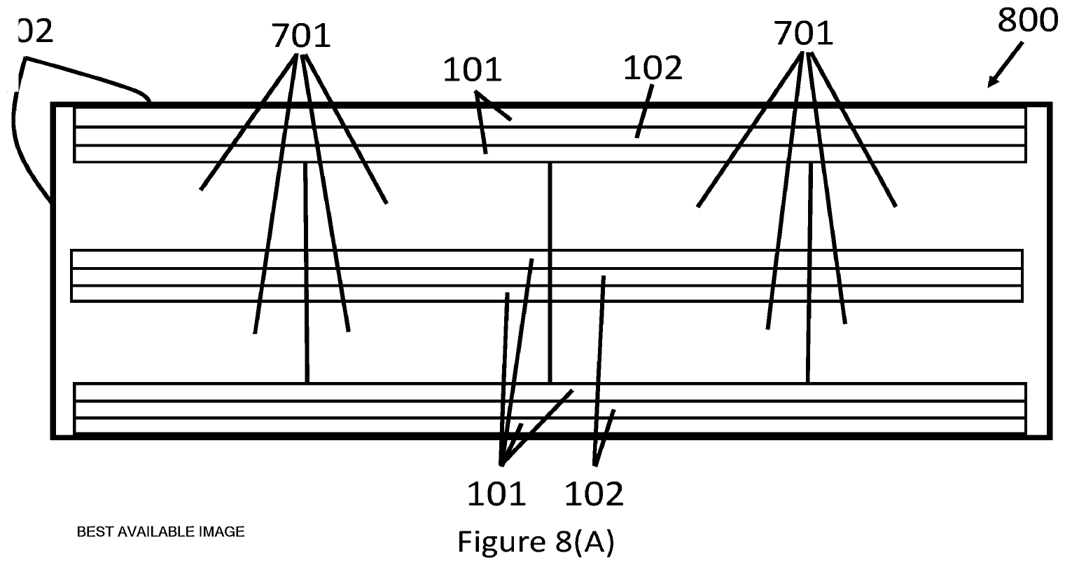

Disclosed herein is a reduced fire propagation element (“RFPE”). The RFPE element may have application in conjunction with a battery pack or internally to the battery pack. Examples are shown in FIGS. 7-11 of how an RFPE element is used in connection with the battery pack. FIG. 9 shows that the RFPE can be disposed on one or more external surfaces of the battery cells 701, e.g., between adjacent vertical surfaces of adjacent battery cells 701, on the exterior surface of the lid of the housing, and on the exterior surface of the floor of the housing.

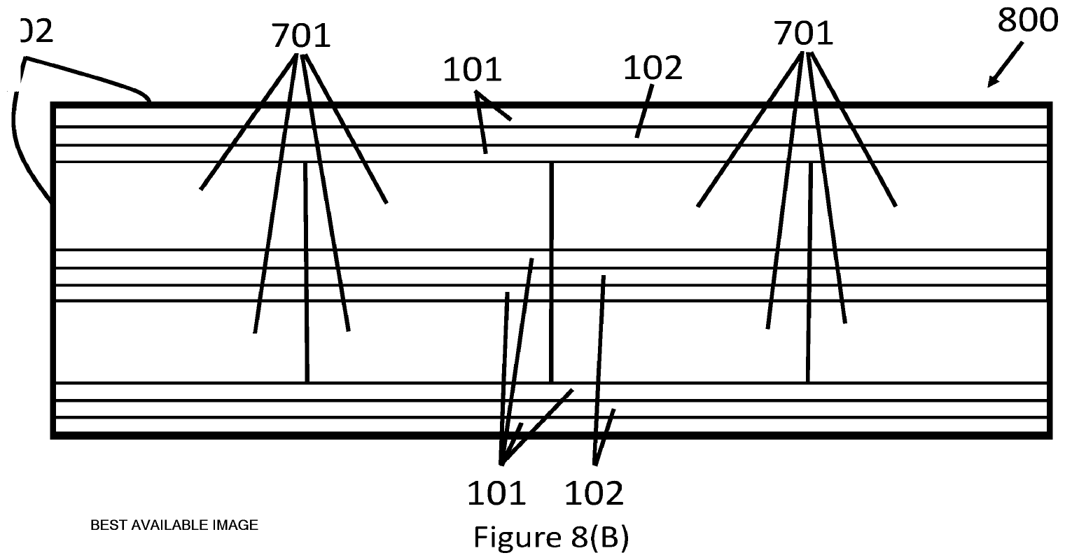

If so desired, RFPEs may be applied to more than one surface of the battery housing 702. As shown in FIG. 10, a first RFPE may be applied to the exterior surface of the lid, a second RFPE may be applied to the exterior surface of the floor and third a RFPE may be applied to each vertical surface of the housing 702, which may be interior (shown) or exterior (not shown). Use of more than one (1) RFPE to a battery housing 702 is not limited to the recited example; it is only illustrative of the possibilities.

Either in conjunction with the above or separate therefrom, the RFPE may be included in the battery housing 702 of the battery pack. The RFPE may be located in the interior battery housing 702. In FIGS. 7-11 which the use of RFPE in any or all of the following either separately or in any combination thereof: the RFPE may be located: (1) on the interior surface of the lid of the battery housing 702; (2) on the interior surface of the floor of the battery housing 702; (3) on one (1) or more of the vertical surfaces of the housing 702 and/or (4) in between two (2) adjacent battery cells 701.

If attachment between the RFPE and the surface of the battery housing is desired, the RFPE may be adhered to the surface of the battery housing 702. Any type of adhesive may be used. Depending on the desired application, the adhesive may be a high temperature adhesive, two (2) examples being a phenolic resin or a carbonizable cement.

Various embodiments of the RFPE are disclosed herein. Each and every one of the RFPE embodiments disclosed herein are equally applicable to the applications discussed above.

In accordance with the present disclosure, the RFPE is an article comprising at least one graphite sheet. In other words, in exemplary embodiments, the RFPE comprises a graphite article. Preferably, the RFPE includes 1st and 2nd flexible graphite sheets 101. The 1st and 2nd graphite sheets may be the same 101 or different 101(a) and 101(b) (not shown). It is preferred that at least one of the flexible graphite sheets 101 have a thermal conductivity of at least about 300 W/mK up to about 2000 W/mK. In particular embodiments both of the flexible graphite sheets have a thermal conductivity of at least about 300 W/mK up to about 2000 W/mK. The flexible graphite sheets may or may not have the same thermal conductivity. Exemplary preferred conductivities may range from at least about 300 W/mK up to about 1200 W/mK. Particular examples of suitable thermal conductivities may include at least about 300 W/mK, at least about 350 W/mK, at least about 400 W/mK, at least about 450 W/mK, at least about 500 W/mK, at least about 800 W/mK, at least about 1000 W/mK, and at least about 1200 W/mK. The afore thermal conductivities are all in-plane thermal conductivity.

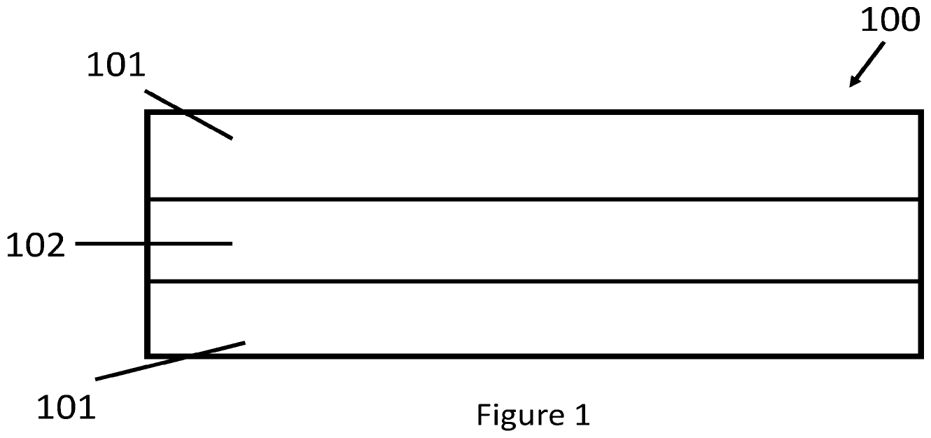

FIG. 1 illustrates an embodiment of the RFPE 100 of the present disclosure in which only one (1) flexible graphite sheet 101(a) has a thermal conductivity of at least 300 W/mK up to 2000 W/mK, such graphite sheet 101(a) will have a density of at least 1.4 g/cc up to 2.1 g/cc; whereas the flexible graphite sheet 101(b) with a thermal conductivity of less than 300 W/mK, down to 250 W/mK, will have a density of less than 1.3 g/cc to 1.0 g/cc. In this embodiment preferably the flexible graphite sheet 101(b) having a density of less than 1.3 g/cc is adjacent to a surface of the battery housing.

The flexible graphite sheets 101 disclosed herein may include one or more flexible graphite sheets of: compressed particles of exfoliated graphite particles, graphitized polyimide and combinations thereof.

Thickness of the flexible graphite sheets 101 may range from at least about 80 microns up to about 2 mm. Exemplary thickness may include any of the followings, as well as dimensions not listed but in the above range: at least about 100 microns, at least about 150 microns, at least about 250 microns, at least about 500 microns, at least about 750 microns, at least about 1 mm, and at least about 1.5 mm.

The flexible graphite sheets 101 disclosed herein do not need to have the same properties, such as but not limited the 1^{st} flexible graphite 101(a) may have a greater or lesser thickness than the 2^{nd} flexible graphite sheet 101(b). This is also true for other properties of the graphite sheets. Alternatively, the flexible graphite sheets 101 may have the same properties or at least three (3) properties that are the same.

The RFPE includes a core 102. A core 102 may comprise a foam and at least one fire retardant material. The sheets of flexible graphite 101 may be disposed on opposing surfaces of the core 102, wherein the sheets have no more than minimal direct contact with each other. Unless otherwise indicated, “minimal direct contact with each other” refers to less than 10% of the total surface area of one of the graphite sheets in direct contact with the other, preferably less than 5% of the total surface area one of the graphite sheets in direct contact with the other. Preferably the flexible graphite sheets 101 are not in contact with each other. This minimal or no direct contact avoids heat transfer from the hot side to the cold side of the RFPE.

The thickness of the core 102 may vary depending on the application of the RFPE. The thickness may be limited due to space limitations in the particular device. Another factor may be relevant to the thickness is the insulation (R-value) value of the core 102. If more insulation is desired, the thickness of the core 102 may be increased or decreases depending on the R-value of the material of construction of the core 102.

Exemplary thickness of the core 102 for application to or within a battery pack 700, 800, 900, 1000, and 1100 may range from at least 20 microns up to 10 mm. In a particular example, the thickness of the core 102 comprises no more than 5 mm.

Examples of materials of construction of the foam core may include a ceramic precursor and/or expanded polymeric materials such as polyurethane, ethylene-vinyl acetate (“EVA”) foam, acrylonitrile butadiene rubber (NBR), polyvinylchloride (PVC) or a polyisocyanate compound; as well as mixtures thereof.

Non-limiting examples of suitable ceramic precursors include silicon generating compounds such as silicone foams formed from at least one of the following compounds: silicon carbide (SiC), silicon oxycarbide (SiOₓC_{y}), silicon nitride (Si₃N₄), silicon carbonitride (Si₃₊ₓN₄C_{x+y}) and silicon oxynitride (SiOₓN_{y}) and combinations thereof.

One embodiment of the foam comprises up to 30% NBR, up to 30% PVC and up to 30% a ceramic precursor. In this example the percentages are percent by weight.

The foams are not required to be but may be syntactic foam, reticulated foam or closed cell foam.

Other materials of construction for the core foam include expanded elastomeric and/or thermoplastic elastomer blend based on styrenic organic polymer and chlorinated organic polymer. The expanded elastomer or thermoplastic elastomer blend itself comprises a styrene substituted organic polymer, preferably styrene butadiene polymer. The styrene substituted polymer shows a styrene content of at least 10%, preferably at least 17%, especially preferably 20% and higher (bound styrene according to ASTM D5775). The styrene substituted organic polymer is present in the formulation in at least 30 phr (parts per hundred rubber, which means, it represents at least 30 percent of the elastomeric content of the claimed material), preferably at least 50 phr, especially preferably at least 70 phr.

The elastomer or thermoplastic elastomer blend furthermore comprises at least 10 phr, preferably at least 30 phr, especially preferred at least 50 phr—related to the styrene substituted polymer—of a chlorinated organic polymer of thermoplastic or thermoplastic elastomer nature, preferably polyvinyl chloride (PVC), chlorinated polyethylene (CPE, CM), chlorosulfonated polyethylene (CSM), or any mixture thereof. Additionally, the elastomer or thermoplastic elastomer blend comprises at least 30 phr, preferably 50 phr, especially 70 phr of halogenated paraffin, halogenated fatty acid substituted glycerine or any combination thereof—representing an oil and/or fat and/or wax—, preferably chloroparaffin and/or chlorinated fatty acid substituted glycerines, especially preferably long-chain chlorinated paraffin (C>17) and/or glycerines substituted with fatty acids with at least respective C>8. The degree of chlorination of the chlorinated paraffin and/or the glycerines substituted with fatty acids is least 15 percent, preferably at least 20 percent, especially preferably at least 30 percent.

The elastomer or thermoplastic elastomer blend may also comprise at least 30 phr, preferably at least 100 phr, especially preferably more than 200 phr of inorganic filler, preferably of metal and/or half metal chalkogen (i.e. compound of oxygen, sulfur) nature. The inorganic filler may be an aluminum compound, such as aluminum silicates, oxides, hydroxides etc., e.g. ATH (aluminum trihydroxyde), and/or a silicon based compound, such as silicates, quartz, zeolites etc., or mineral based accordingly, e.g. on gypsum, clay, perlite, vermiculite, chalk, slate, graphite, talc/mica etc., or any mixtures thereof.

The elastomer or thermoplastic elastomer blend is expanded to a mainly closed cell foam with a closed cell content of at least 80% and to a density of less than 100 kg/m3, preferably less than 65 kg/m3, especially preferred less than 50 kg/m3 according to ISO 845 to lower the thermal conductivity to less than 0.075 W/mK at 0° C., preferably less than 0.040 W/mK at 0° C., especially preferably less than 0.035 W/mK at 0° C. according to EN 12667.

An example of an embodiment of expanded polymeric material may include at least 300 phr, but less than 1000 phr ingredients in total, comprising 100 phr of at least two polymers, of which 1) at least 55 phr is polyvinyl chloride (PVC) or vinyl chloride copolymer or vinyl chloride terpolymer or a mixture thereof, and 2) at least 10 phr is at least one additional chlorinated organic polymer that is crosslinked by sulfur and/or metal oxides and/or thiadiazoles.

The elastomer or thermoplastic elastomer blend may comprise further additives such as flame retardants and synergists, biocides, plasticizers, stabilizers (e.g. versus UV, ozone, reversion etc.), colors etc., of any kind in any ratio, including additives for improving its manufacturing, application, aspect and performance properties, such as inhibitors, retarders, accelerators, etc.; and/or additives for adapting it to the applications' needs, such as char-forming and/or intumescent additives, like expanding graphite, to render the material self-intumescent in case of fire, e.g. for general protection purposes and/or to close and protect e.g. wall and bulkhead penetrations; and/or substances that will lead to a self-ceramifying effect to pipes, wall penetrations etc. in case of fire, such as boron compounds, silicon containing compounds etc.; and/or internal adhesion promoters to ensure self-adhesive properties in co-extrusion and co-lamination applications, such as silicate esters, functional silanes, polyols, etc.

An embodiment to enhance sufficient fire resistance and low smoke development, the use of non-halogenated polymers should be limited to less than 30 phr, preferably less than 20 phr, especially preferred to less than 10 phr. The feasible quantity of non-halogenated polymers depends on the required fire and smoke performance as well as on the required dimensions and densities of the material, due to the impact on fire load.

The core 102 may also include one or more fire retardant materials. A preferred type of fire retardant material is an intumescent material. A type of suitable intumescent material comprises expandable graphite. The expandable graphite may be used with one or more other fire retardant materials. Other suitable fire retardants may include at least one from Mg(OH)₃, alumina trihydrate (ATH), ammonium polyphosphate (APP), melamine polyphosphate (MPP), zinc borate and combinations thereof.

Properties of suitable expandable graphite include an onset temperature of at least about 160° C. Typically the onset temperature will not be more than 350° C. Exemplary onset temperatures may include at least about 180° C., at least about 200° C., at least about 220° C., at least about 250° C. or at least about 280° C.

Particle sizing of the expandable graphite may comprise at least about 325 mesh. Particles size may range up to about 20 mesh, as well as any and all combinations of particle sizes between about 325 mesh up to about 20 mesh, in terms of microns this is a range of about 44 to 850 microns. Other examples of suitable particle sizes include 50 or 80 mesh expandable graphite flake.

Suitable loading levels of the core 102 with expandable graphite may include at least about two (2%) percent by weight (pbw) of the expandable graphite. A maximum loading level may be up to about fifty (50%) pbw. Any range in between 2% by weight and 50% by weight, e.g., 2-40% by weight, 2-30% by weight, 2-20% by weight, 2-10%, 5-40% by weight, 5-30% by weight, 5-20% by weight, 5-10% by weight and so on, is acceptable. Pbw is used herein to mean the percentage by weight of the overall article.

In accordance with the present disclosure, the flexible graphite sheets 101 may be attached to the core. Preferably, the flexible graphite sheets 101 are adhered to the core 102. Any suitable type of adhesive may be used. The above description regarding adhesives is incorporated herein. Optionally, if so desired, a fire resistant adhesive may be used to adhere each flexible graphite sheets 101 to the core 102. In a further option the fire resistant adhesive may be used to adhere one of the flexible graphite sheets 101 to the core 102 and a non-fire resistant adhesive may be used with the other flexible graphite sheet 101 to adhere it to the core 102. In the embodiment in which the two (2) types of adhesives are used, it is preferred that the non-fire resistant adhesive is adjacent to the surface of the battery housing 602. Stated alternatively, the fire resistant adhesive would be adjacent to the plurality of battery cells 601.

Preferably, the RFPE is devoid of one (1) or more structural supports between the flexible graphite sheets 101. This comment is relative to all embodiments of the RFPE disclosed herein as well as those conceived within the scope of the disclosure.

Turning to an alternate embodiment, the core 102 may comprise an insulation material comprising material other than a foam material and optionally at least one fire retardant material. The core material may comprise one of more of the following: mica, aerogel, woven mesh, silicone, ceramic, glass fibers, carbon fibers, mineral wool such as but not limited to high temperature mineral wool such as Kaolwool, gypsum board, concrete, titanium, nickel alloys (such as but not limited to HASTELLOY), and combinations thereof. The above disclosure regarding fire retardant materials is equally applicable to the core comprising a material other than a foam.

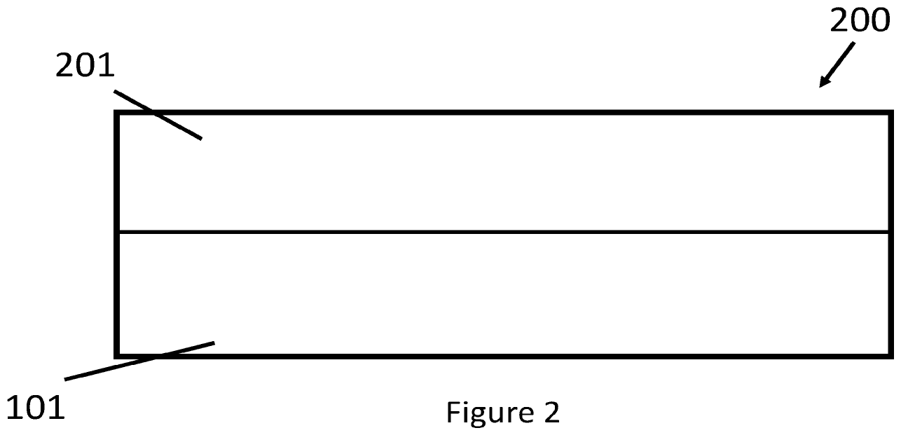

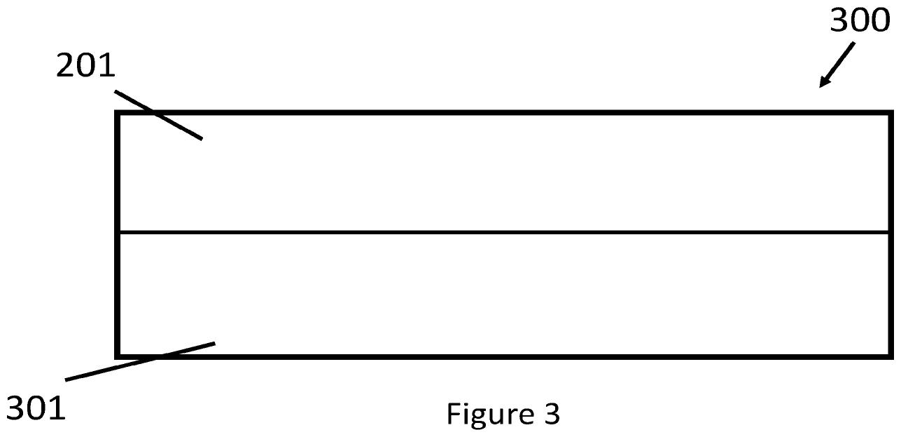

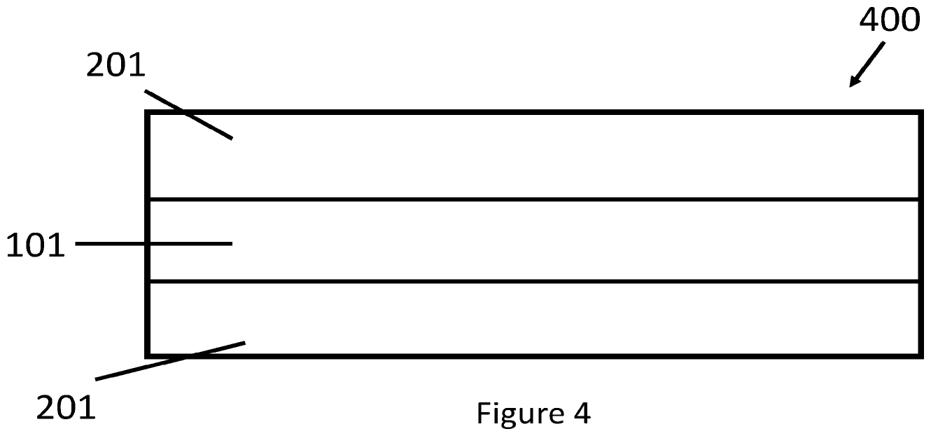

FIG. 4 demonstrates a RFPE 400 of the present disclosure that may include the insulation material as the outer layers 201 and the flexible graphite as a core layer 101. In another embodiment shown in FIG. 2, the RFPE 200 comprises at least one flexible graphite sheet 101 attached to an insulation layer 201. In another alternate embodiment shown in RFPE 300 in FIG. 3, the flexible graphite sheet 101 (not shown in FIG. 3) of RFPE 200 may be replaced or used in combination with a graphite doped silicon layer 301 adjacent to an insulation layer 201. The graphite additive for the dope of the silicon layer may include graphite powder, expandable graphite powder or combinations thereof.

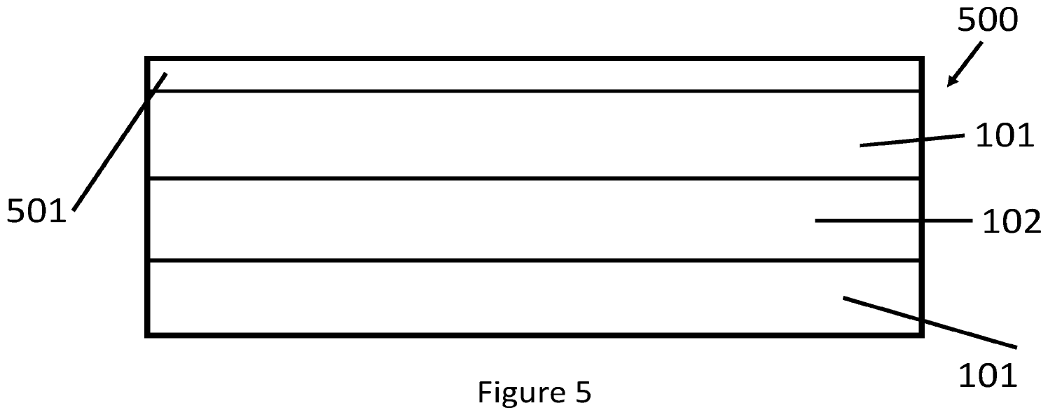

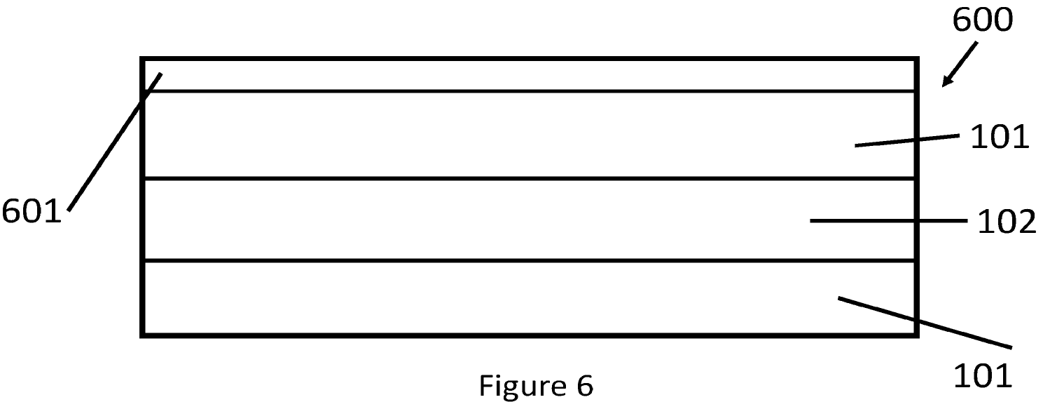

FIG. 5 illustrates a RFPE 500 that may include a metallic backing layer 501 adjacent to one of the flexible graphite sheets 101. Suitable types of metals may include steel, aluminum, copper and alloys thereof. FIG. 6 illustrates a RFPE 600 that may include an electrically isolating layer 601. The electrically isolating layer 601 would be an outer most layer of any such embodiment in which it is included. An example of a suitable material to form the electrically isolating layer 601 may include a polyimide.

An advantage of the RFPEs disclosed herein is an improvement of inhibiting fire propagation. The RFPEs disclosed herein may be used to provide up to 50 minutes of inhibited fire propagation in an article of manufacture at a temperature of up to 350° C.

### Examples

The reduction in fire propagation of various samples was tested.

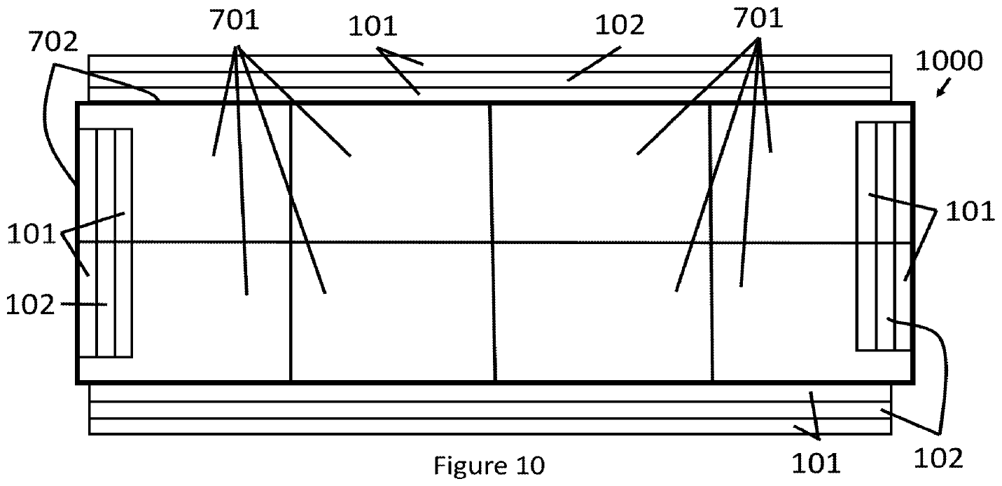

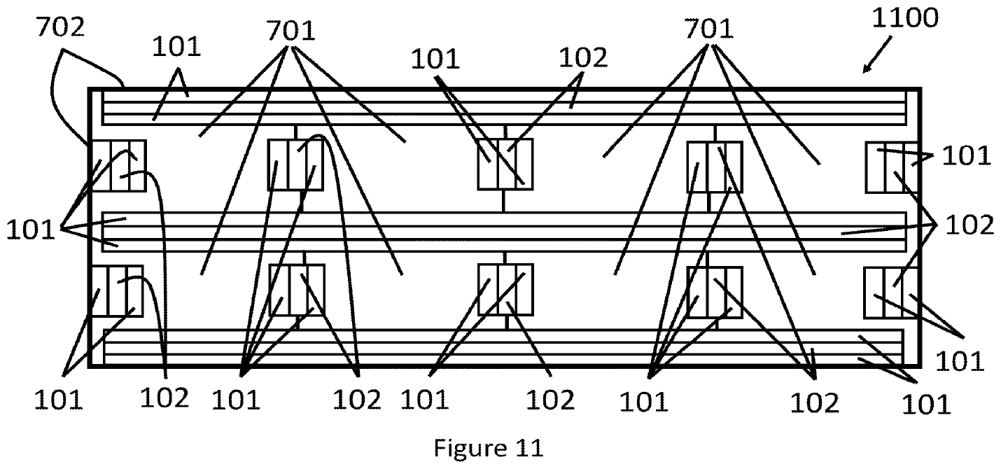

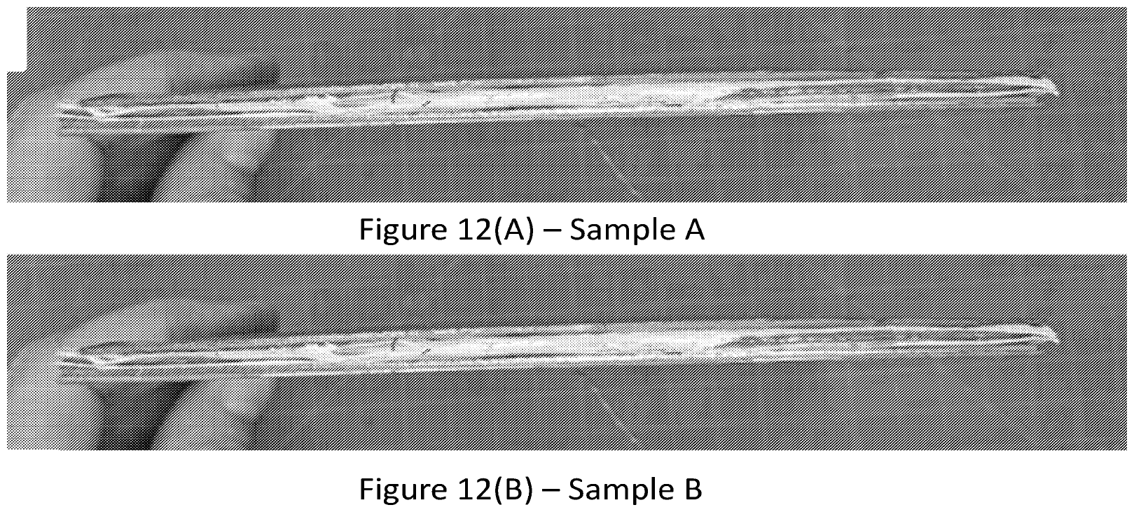

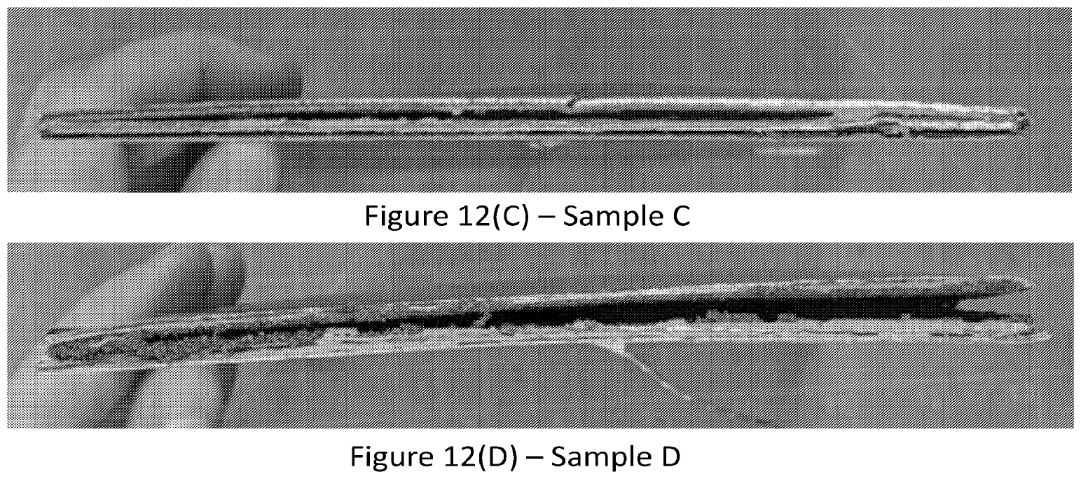

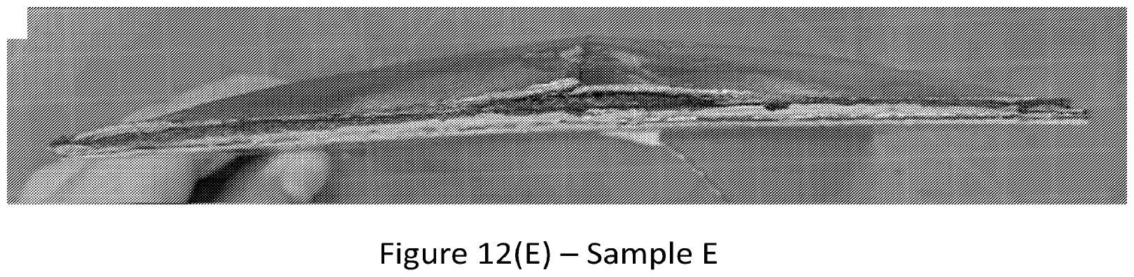

Configuration of the five samples configurations in accordance the RFPE's disclosed herein and a control.
Sample A: Flexible graphite—250 micron aerogel—flexible graphite (thickness about 4.5 mm) (shown in FIG. 12(a))
Sample B: Flexible graphite—ceramic wool and mica layer—flexible graphite (thickness about 4.5 mm) (shown in FIG. 12(b))
Sample C: Flexible graphite—woven mesh and mica layer—flexible graphite (thickness about 3.3 mm) (shown in FIG. 12(c))
Sample D: Flexible graphite—silicone with expandable graphite—flexible graphite (thickness about 3.85 mm) (shown in FIG. 12(d))
Sample E: Flexible graphite—ceramic precursor foam with expandable graphite—flexible graphite (thickness about 4.5 mm) (shown in FIG. 12(e))
Control: Flexible graphite bonded to a steel plate (not shown)

Each flexible graphite sheet 101 had a thermal conductivity of 400 W/mK and a thickness of 0.94 mm. Each sample was bonded to 0.59 mm thick galvanized steel sheet metal piece. A fire-proof adhesive was used to combine the components of each sample such as Cotronics Resbond 907. The samples were layered up and cured under low weight to ensure adherence between adjacent layers.

Each sample was six (6″) inches by six (6″) inches.

The samples were secured in a test fixture. A heat source which provides a flame at ˜10,000 BTU (˜3,000 W) was used. The temperatures were taken at the top (surface opposite the flame) and bottom (surface adjacent to the flame) centers of each sample. While the flame temperature is about 800-900° C., the temperature on the bottom surface was expected to be in the 500-600° C. range. Each sample was heated for fifty (50) minutes and the temperature drop through the thickness of each sample was measured (delta (A) T between the bottom surface temperature and the top surface temperature). The delta T reported is an average taken over the last five (5) minutes of the fifty (50) minute testing period.

TABLE 1

| Sample | Bottom Surface (° C.) | Top Surface (° C.) | ΔT (° C.) |
|---|---|---|---|
| Sample A | 382.34 | 197.9 | 184.44 |
| Sample B | 373.63 | 209.23 | 164.4 |
| Sample C | 394.46 | 254.07 | 140.39 |
| Sample D | 390.67 | 240.25 | 150.42 |
| Sample E | 417.44 | 212.1 | 205.34 |
| Control | 415.71 | 238.84 | 176.87 |

Sample E the laminate with flexible graphite—ceramic precursor foam with expandable graphite—flexible graphite exhibited the largest delta T by more than ten (10%) percent than the closest other sample (Sample A) and the control and over forty-five (45%) percent more than the sample with the lowest delta T (Sample C).

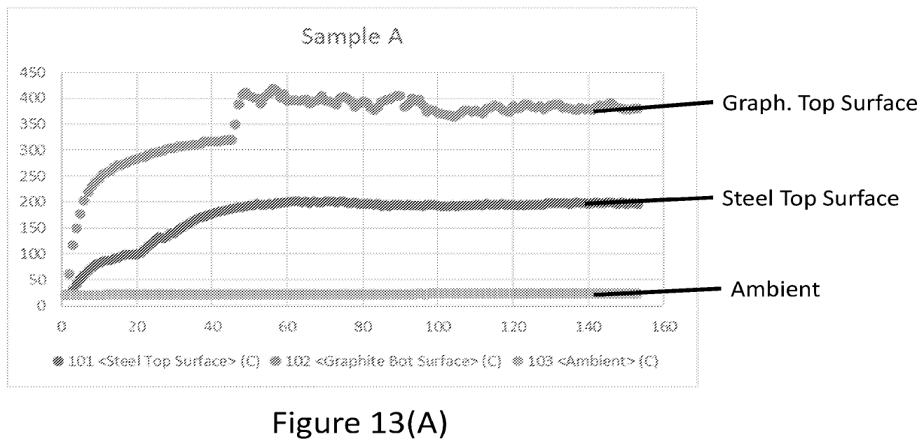

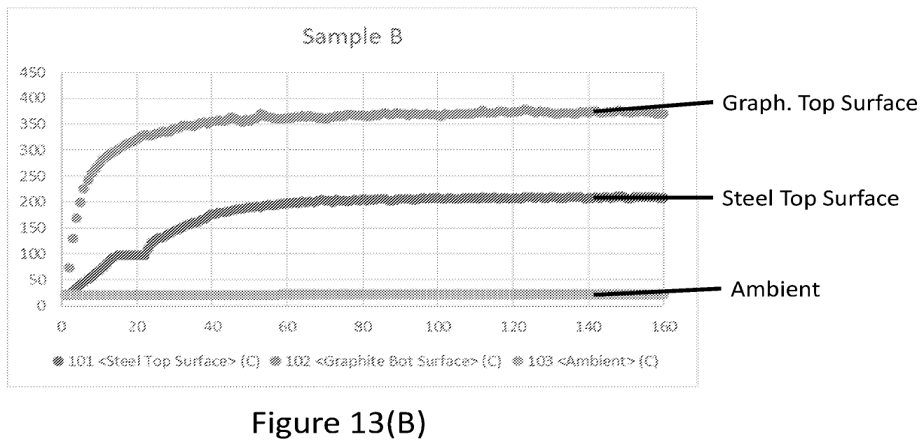

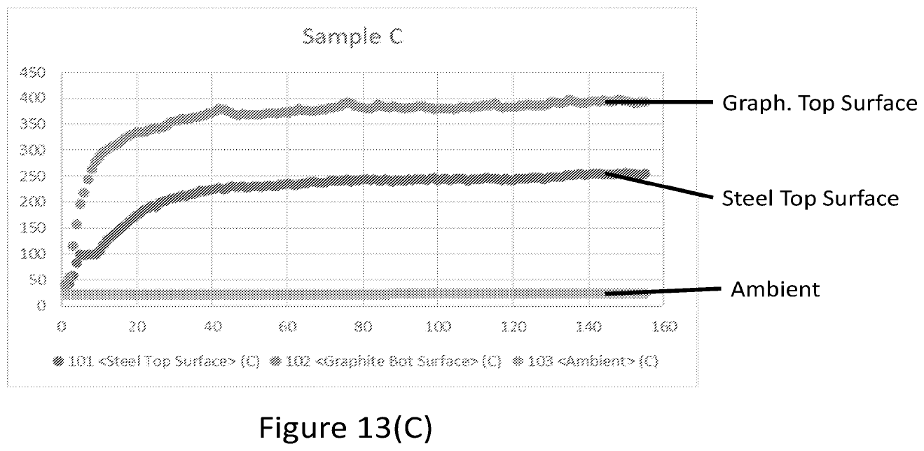

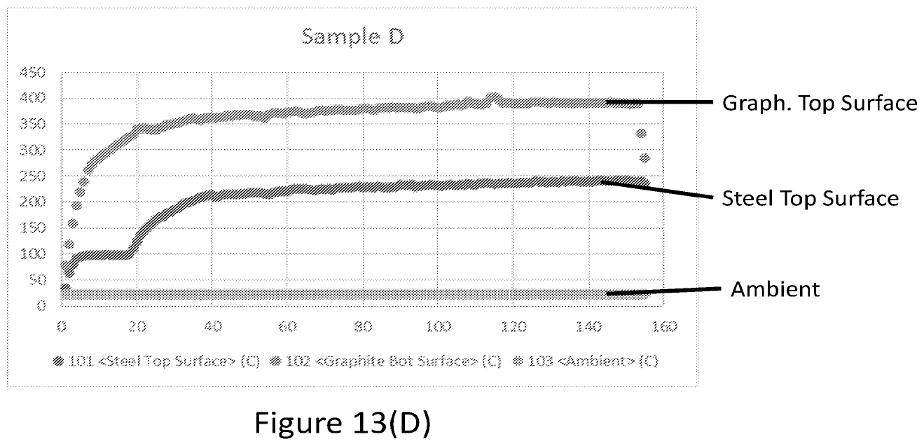

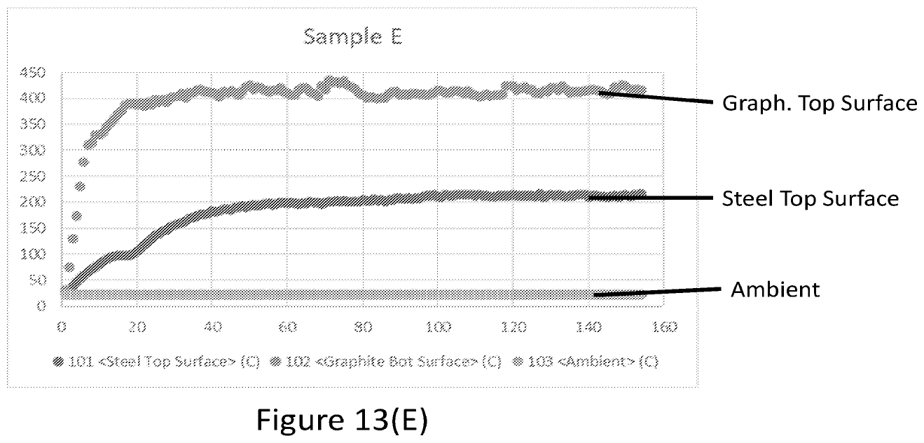

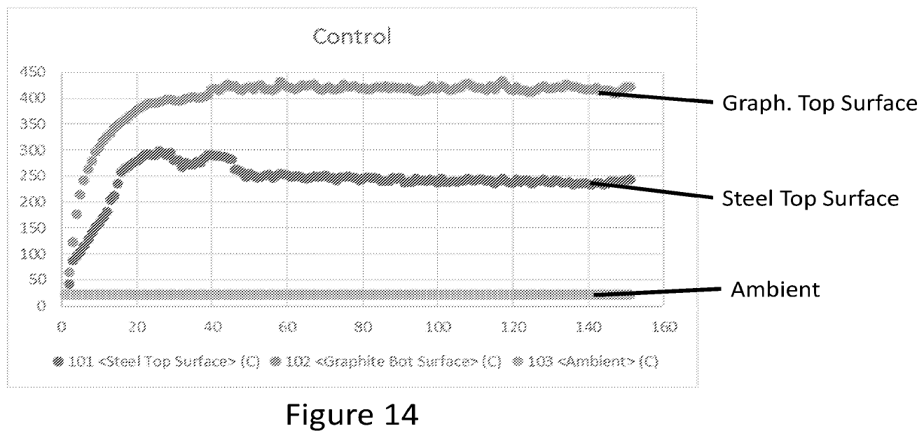

Temperature curves for each sample and the control are provided in FIGS. 13(A)-13(E) and 14.

Illustrated in FIGS. 12(A-E) are side views of samples A-E. As shown for each sample that included expandable graphite, samples D & E, the graphite expanded thereby forming a char layer and providing the benefit of volume expansion.

The disclosures of all cited patents and publications referred to in this application are incorporated herein by reference in their entirety. The various embodiments disclosed herein may be practiced in any combination thereof. The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

All references to singular characteristics or limitations of the present disclosure shall include the corresponding plural characteristic or limitation, and vice versa, unless otherwise specified or clearly implied to the contrary by the context in which the reference is made. Thus, in the present disclosure, the words “a” or “an” are to be taken to include both the singular and the plural. Conversely, any reference to plural items shall, where appropriate, include the singular.

Unless otherwise indicated (e.g., by use of the term “precisely”), all numbers expressing quantities, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention.

If not stated herein thermal conductivities are provided at room temperature and standard pressure (1 atm) or alternatively at the appropriate testing conditions if a standard testing protocol is known such as ASTM D 5470 for through plane conductivity of flexible graphite articles.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The shielding article of the present disclosure can comprise, consist of, or consist essentially of the essential elements and limitations of the disclosure as described herein, as well as any additional or optional ingredients, components, or limitations described herein or otherwise useful in shielding articles.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use.

### Exemplary Embodiments

1. An article comprising:
a. 1st and 2nd flexible graphite sheets, each flexible graphite sheet having a thickness of at least 0.25 mm and a thermal conductivity of at least 300 W/mK;
b. a core comprising a foam and at least one fire retardant material, wherein the sheets of flexible graphite disposed on opposing surfaces of the core, wherein the sheets have no more than minimal direct contact with each other.
2. The article of exemplary embodiment 1 wherein a thickness of the core comprises no more than 10 mm.
3. The article of exemplary embodiment 1 or 2 wherein the foam comprises at least one of ceramic precursor, polyurethane ethyl-vinyl acetate, or a polyisocyanate compound.
4. The article of exemplary embodiment 3 wherein the ceramic precursor comprises at least one of the following compounds: silicon carbide (SiC), silicon oxycarbide (SiOₓC_{y}), silicon nitride (Si₃N₄), silicon carbonitride (Si₃₊ₓN₄C_{x+y}) and silicon oxynitride (SiOₓN_{y}) and combinations thereof.
5. The article of exemplary embodiment 1, 2, 3 or 4 wherein a thickness of the core comprises no more than 5 mm and the thickness of each of the flexible graphite sheet comprises at least 0.5 mm.
6. The article of exemplary embodiment 1, 2, 3, 4 or 5 wherein the fire retardant comprises expandable graphite.
7. The article of exemplary embodiment 6 wherein a loading level of the expandable graphite comprises at least 2% by weight.
8. The article of exemplary embodiment 6 or 7 wherein a loading level of the expandable graphite comprises up to 50% by weight.
9. The article of exemplary embodiment 6, 7 or 8 wherein an onset temperature of the expandable graphite comprises at least 160° C.
10. The article of exemplary embodiment 6, 7, or 8 wherein an onset temperature of the expandable graphite comprises less than 350° C.
11. The article of exemplary embodiment 6, 7, 8, 9 or 10 wherein the expandable graphite has a size of at least 325 mesh.
12. The article of exemplary embodiment 6, 7, 8, 9, 10 or 11 wherein the mesh comprises no more than 20 mesh.
13. The article of exemplary embodiment 6, 7, 8, 9, 10, 11, or 12 wherein the fire retardant comprises at least one other fire retardant in addition to the expandable graphite.
14. The article of exemplary embodiment 13 wherein the one other fire retardant comprises at least one from Mg(OH)₃, alumina trihydrate (ATH), ammonium polyphosphate (APP), melamine polyphosphate (MPP), zinc borate and combinations thereof.
15. The article of any one of exemplary embodiments 1-14 devoid of one or more structural supports between the flexible graphite sheets.
16. An article comprising:
a. 1^{st} and 2^{nd} flexible graphite sheets, each flexible graphite sheet having a thickness of at least 0.25 mm and a thermal conductivity of at least 300 W/mK;
b. a core comprising at least one fire retardant material and an insulation material comprising at least one of, mica, aerogel, woven mesh, silicone, glass fibers, carbon fibers, mineral wool, gypsum board, concrete, titanium, Nickel-alloys and combinations thereof, wherein the sheets of flexible graphite disposed on opposing surface of the core, wherein the sheets have no more than minimal direct contact with each other.
17. The article of exemplary embodiment 16 wherein a thickness of the core comprises no more than 5 mm and the thickness of each of the flexible graphite sheet comprises at least 0.5 mm.
18. The article of exemplary embodiment 16 wherein the fire retardant comprises expandable graphite.
19. The article of exemplary embodiment 18 wherein a loading level of the expandable graphite comprises at least 2% by weight.
20. The article of exemplary embodiment 18 wherein a loading level of the expandable graphite comprises up to 50% by weight.
21. The article of exemplary embodiment 18, 19 or 20 wherein an onset temperature of the expandable graphite comprises at least 160° C.
22. The article of exemplary embodiment 18, 19 or 20 wherein an onset temperature of the expandable graphite comprises less than 350° C.
23. The article of exemplary embodiment 18, 19, 20, 21, or 22 wherein the expandable graphite has a size of at least 325 mesh.
24. The article of exemplary embodiment 18, 19, 20, 21, 22 or 23 wherein the mesh comprises no more than 20 mesh.
25. The article of exemplary embodiment 18, 19, 20, 21, 22, 23, or 24 wherein the fire retardant comprises at least one other fire retardant in addition to the expandable graphite.
26. The article of exemplary embodiment 25 wherein the one other fire retardant comprises at least one from Mg(OH)₃, alumina trihydrate (ATH), ammonium polyphosphate (APP), melamine polyphosphate (MPP), zinc borate and combinations thereof.
27. The article of any one of exemplary embodiments 16-26 devoid of one or more structural supports between the flexible graphite sheets.
28. A shielding article comprising:
a. 1^{st} and 2^{nd} flexible graphite sheets, each flexible graphite sheet having a thickness of at least 0.10 mm and a thermal conductivity of at least 300 W/mK;
b. a core comprising a foam and at least one fire retardant material, wherein the sheets of flexible graphite disposed on opposing surface of the core, wherein the sheets have no more than minimal direct contact with each other.
29. The article of exemplary embodiment 28 wherein a thickness of the core comprises no more than 10 mm.
30. The article of exemplary embodiment 29 wherein the foam comprises at least one of ceramic precursor, polyurethane ethyl-vinyl acetate, or a polyisocyanate compound.
31. The article of exemplary embodiment 30 wherein the ceramic precursor comprises at least one of the following compounds: silicon carbide (SiC), silicon oxycarbide (SiOₓC_{y}), silicon nitride (Si₃N₄), silicon carbonitride (Si₃₊ₓN₄C_{x+y}) and silicon oxynitride (SiOₓN_{y}) and combinations thereof.
32. The article of any one of exemplary embodiments 28-31 wherein a thickness of the core comprises no more than 5 mm and the thickness of each of the flexible graphite sheet comprises at least 0.5 mm.
33. The article of exemplary embodiment 32 wherein the fire retardant comprises expandable graphite.
34. The article of exemplary embodiment 33 wherein a loading level of the expandable graphite comprises at least 2% by weight.
35. The article of exemplary embodiment 33 wherein a loading level of the expandable graphite comprises up to 50% by weight.
36. The article of exemplary embodiment 33, 34 or 35 wherein an onset temperature of the expandable graphite comprises at least 160° C.
37. The article of exemplary embodiment 33, 34 or 35 wherein an onset temperature of the expandable graphite comprises less than 350° C.
38. The article of any one of exemplary embodiments 33-37 wherein the expandable graphite has a size of at least 325 mesh.
39. The article of any one of preceding exemplary embodiments 33-38 wherein the mesh comprises no more than 20 mesh.
40. The article of any one of preceding exemplary embodiments 33-38 wherein the fire retardant comprises at least one other fire retardant in addition to the expandable graphite.
41. The article of exemplary embodiment 40 wherein the one other fire retardant comprises at least one from Mg(OH)₃, alumina trihydrate (ATH), ammonium polyphosphate (APP), melamine polyphosphate (MPP), zinc borate and combinations thereof.
42. The article of any one of exemplary embodiments 28-41 devoid of one or more structural supports between the flexible graphite sheets.
43. A composite article comprising an insulation layer having a thickness of at least 10 microns, the insulation able to withstand a temperature of a least 350° C. for a period of at least fifty minutes in an oxygen environment and one of either a flexible graphite layer having a thickness of at least 0.25 mm and a thermal conductivity of at least 300 W/mK or a graphite doped silicon composite.
44. The article of exemplary embodiment 43 wherein the insulation layer comprises at least one from the group of talc, mica, aerogel, woven mesh, silicone, glass fibers, carbon fibers, ceramic fibers, ceramic wool, mineral wool, gypsum board, concrete, titanium, nickel-alloys and combinations thereof.
45. The composite article of exemplary embodiment 43 wherein the insulation layer comprises a fully dense insulation.
46. The composite article of exemplary embodiment 43 wherein the insulation layer comprises a refractory material.
47. The composite article of any one of the preceding exemplary embodiments 43-46 wherein the thickness of the insulation layers comprises at least about 100 microns up to about 10 mm.
48. The composite article of any one of the exemplary embodiments 43-47 wherein the insulation thickness comprises at least 1 mm.
49. The composite article of any one of the preceding exemplary embodiments 43-48 wherein in the insulation layer comprises at least one of inorganic fibers, non-metallic fibers and combinations thereof.
50. The composite article of any one of the preceding exemplary embodiments 43-49 wherein the insulation layer constructed from at least one of the following: alumina, zirconia, borates, silica, carbide, alloys thereof and combinations thereof.
51. The composite article of exemplary embodiment 50 wherein the alloys comprise nitrides.
52. The composite article of any one of the preceding exemplary embodiments 43-51 further comprising a second insulation layer, disposed adjacent the flexible graphite layer, wherein the graphite forms a core of the composite.
53. The article of exemplary embodiment 52 wherein the second insulation layer comprises at least one from the group of talc, mica, aerogel, woven mesh, silicone, glass fibers, carbon fibers, ceramic fibers, ceramic wool, mineral wool, gypsum board, concrete, titanium, Nickel-alloys and combinations thereof.
54. The composite article of exemplary embodiment 53 wherein the second insulation layer comprises a fully dense insulation.
55. The composite article of exemplary embodiment 54 wherein the second insulation layer comprises a refractory material.
56. The composite article of any one of the preceding exemplary embodiments 52-55 wherein the thickness of the second insulation layers comprises at least about 100 microns up to about 10 mm.
57. The composite article of any one of the exemplary embodiments 52-56 wherein the second insulation thickness comprises at least 1 mm.
58. The composite article of any one of the preceding exemplary embodiments 52-57 wherein in the second insulation layer comprises at least one of inorganic fibers, non-metallic fibers and combinations thereof.
59. The composite article of any one of the preceding exemplary embodiments 52-58 wherein the second insulation layer constructed from at least one of the following: alumina, zirconia, borates, silica, carbide, alloys thereof and combinations thereof.
60. The composite article of exemplary embodiment 59 wherein the alloys comprise nitrides.
61. The composite article of any one of the preceding exemplary embodiments 43-55 wherein the insulation layer devoid of an organic binder.
62. The composite article of any one of preceding exemplary embodiments 53-61 wherein the second insulation layer devoid of an organic binder.
63. A shielding article comprising the composite article of any one of the preceding exemplary embodiments 43-62, further including a metallic backing layer.
64. The shielding article of exemplary embodiment 63 further comprising an electrically isolating outer most layer.
65. A battery pack comprising:
a. a battery housing having more than one surface;
b. a plurality of battery cells located in the battery housing; and
c. the article of any one of the preceding exemplary embodiments 43-63 in contact with at least one of the more than one surface of the battery housing.
66. The battery pack of exemplary embodiment 65 wherein the article disposed on one of an interior side or an exterior side of the surface of the battery housing.
67. A battery pack comprising:
a. a battery housing having more than one surface;
b. a plurality of battery cells located in the battery housing;
c. first and second articles in accordance with any one of the preceding exemplary embodiments 43-64, the first article in contact with at least one of the more than one surface of the battery housing; and
d. the second article in contact with a different surface of the battery housing than the first article.
68. A battery pack comprising:
a. a battery housing having more than one surface;
b. a plurality of battery cells located in the battery housing;
c. first and second articles in accordance with any one of the preceding exemplary embodiments 43-64, the first article in contact with at least one of the more than one surface of the battery housing; and
d. the second article disposed between two adjacent battery cells.
69. A battery pack comprising:
a. a battery housing having more than one surface;
b. a plurality of battery cells located in the battery housing; and
c. the article of any one of the preceding exemplary embodiments in contact with at least one of the more than one surface of the battery housing.
70. The battery pack of exemplary embodiment 69 wherein the article disposed on one of an interior side or an exterior side of the surface of the battery housing.
71. A battery pack comprising:
a. a battery housing having more than one surface;
b. a plurality of battery cells located in the battery housing;
c. first and second articles in accordance with any one of the preceding claims 1-4, the first article in contact with more than one surface of the battery housing; and
d. the second article in contact with a different surface of the battery housing than the first article.
72. A battery pack comprising:
a. a battery housing having more than one surface;
b. a plurality of battery cells located in the battery housing;
c. first and second articles in accordance with any one of the preceding claims 1-4, the first article in contact with more than one surface of the battery housing; and
d. the second article disposed between two adjacent battery cells.

1-9. (canceled)

10. An article comprising:
a. First and second flexible graphite sheets, each flexible graphite sheet having a thickness of at least 0.25 mm and a thermal conductivity of at least 300 W/mK;
b. a core comprising a foam and at least one fire retardant material, wherein the first and second sheets of flexible graphite disposed on opposing surfaces of the core, wherein the first and second sheets have no more than minimal direct contact with each other.

11. A shielding article comprising the article of claim 10, further including a metallic backing layer.

12. A battery pack comprising:
a. a battery housing having more than one surface;
b. a plurality of battery cells located in the battery housing;
c. a first article in accordance with the article of claim 10, and a second article in accordance with the article of claim 10, the first article in contact with at least one of the more than one surface of the battery housing; and
d. the second article in contact with a different surface of the battery housing than the first article.

13. A battery pack comprising:
a. a battery housing having more than one surface;
b. a plurality of battery cells located in the battery housing;
c. a first article in accordance with the article of claim 10, and a second article in accordance with the article of claim 10, the first article in contact with at least one of the more than one surface of the battery housing; and
d. the second article disposed between two adjacent battery cells.

14. A battery pack comprising:
a. a battery housing having more than one surface;
b. a plurality of battery cells located in the battery housing; and
c. the article of claim 10 in contact with at least one of the more than one surface of the battery housing.

15. A battery pack comprising:
a. a battery housing having more than one surface;
b. a plurality of battery cells located in the battery housing;
c. a first article in accordance with the article of claim 10, and a second article in accordance with the article of claim 10, the first article in contact with more than one surface of the battery housing; and
d. the second article in contact with a different surface of the battery housing than the first article.

16. A battery pack comprising:
a. a battery housing having more than one surface;
b. a plurality of battery cells located in the battery housing;
c. a first article in accordance with the article of claim 10, and a second article in accordance with the article of claim 10, the first article in contact with more than one surface of the battery housing; and
d. the second article disposed between two adjacent battery cells.

17. An article comprising:
a. First and second flexible graphite sheets, each flexible graphite sheet having a thickness of at least 0.25 mm and a thermal conductivity of at least 300 W/mK;
b. a core comprising an insulation material comprising at least one of, mica, aerogel, woven mesh, silicone, glass fibers, carbon fibers, mineral wool, gypsum board, concrete, titanium, Nickel-alloys and combinations thereof and at least one fire retardant material, wherein the first and second sheets of flexible graphite disposed on opposing surfaces of the core, wherein the first and second sheets have no more than minimal direct contact with each other.

18. A shielding article comprising the article of claim 17, further including a metallic backing layer.

19. A battery pack comprising:
a. a battery housing having more than one surface;
b. a plurality of battery cells located in the battery housing;
c. a first article in accordance with the article of claim 17, and a second article in accordance with the article of claim 17, the first article in contact with at least one of the more than one surface of the battery housing; and
d. the second article in contact with a different surface of the battery housing than the first article.

20. A battery pack comprising:
a. a battery housing having more than one surface;
b. a plurality of battery cells located in the battery housing;
c. a first article in accordance with the article of claim 17, and a second article in accordance with the article of claim 17, the first article in contact with at least one of the more than one surface of the battery housing; and
d. the second article disposed between two adjacent battery cells.

21. A battery pack comprising:
a. a battery housing having more than one surface;
b. a plurality of battery cells located in the battery housing; and
c. the article of claim 17 in contact with at least one of the more than one surface of the battery housing.

22. A battery pack comprising:
a. a battery housing having more than one surface;
b. a plurality of battery cells located in the battery housing;
c. a first article in accordance with the article of claim 17, and a second article in accordance with the article of claim 17, the first article in contact with more than one surface of the battery housing; and
d. the second article in contact with a different surface of the battery housing than the first article.

23. A composite article comprising an insulation layer having a thickness of at least 10 microns, the insulation able to withstand a temperature of a least 350° C. for a period of at least fifty minutes in an oxygen environment and one of either a flexible graphite layer having a thickness of at least 0.25 mm and a thermal conductivity of at least 300 W/mK or a graphite doped silicon composite.

24. A shielding article comprising the composite article of claim 23, further including a metallic backing layer.

25. A battery pack comprising:
a. a battery housing having more than one surface;
b. a plurality of battery cells located in the battery housing;
c. a first article in accordance with the composite article of claim 23, and a second article in accordance with the composite article of claim 23, the first article in contact with at least one of the more than one surface of the battery housing; and
d. the second article in contact with a different surface of the battery housing than the first article.

26. A battery pack comprising:
a. a battery housing having more than one surface;
b. a plurality of battery cells located in the battery housing;
c. a first article in accordance with the composite article of claim 23, and a second article in accordance with the composite article of claim 23, the first article in contact with at least one of the more than one surface of the battery housing; and
d. the second article disposed between two adjacent battery cells.

27. A battery pack comprising:
a. a battery housing having more than one surface;
b. a plurality of battery cells located in the battery housing; and
c. the composite article of claim 23 in contact with at least one of the more than one surface of the battery housing.

28. A battery pack comprising:
a. a battery housing having more than one surface;
b. a plurality of battery cells located in the battery housing;
c. a first article in accordance with the composite article of claim 23, and a second article in accordance with the composite article of claim 23, the first article in contact with more than one surface of the battery housing; and
d. the second article in contact with a different surface of the battery housing than the first article.

29. A battery pack comprising:
a. a battery housing having more than one surface;
b. a plurality of battery cells located in the battery housing;
c. a first article in accordance with the composite article of claim 23, and a second article in accordance with the composite article of claim 23, the first article in contact with more than one surface of the battery housing; and
d. the second article disposed between two adjacent battery cells.
